(19) United States
(12) Patent Application Publication
(10) Pub. No.: US 2006/0265230 A1
(43) Pub. Date: Nov. 23, 2006

(54) Environment rating evaluation method and system thereof

(75) Inventor: Masayoshi Shiga, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Non-Profit Organization Ecolink21, Tokyo (JP)

(21) Appl. No.: 10/553,875

(22) PCT Filed: Apr. 22, 2004
(86) PCT No.: PCT/JP04/05779

§ 371 Date: Jul. 25, 2006

(30) Foreign Application Priority Data
Apr. 22, 2003 (JP) 2003-117703

(51) Int. Cl. G06Q 99/00

(52) U.S. Cl. 705/1

(57) ABSTRACT

The present invention provides a method and system for performing an environment rating evaluation using objective numerical value data. The present invention relates to an environment rating evaluation method, and a system thereof, which comprises the steps of: having a rating subject such as a rating subject business enterprise input predetermined response information into primary survey items of a predetermined environment rating distributed via a network, and return the response information to a rating evaluator; having the evaluator distribute secondary survey items to the subject, perform a primary interview survey, and conduct an investigation through data processing on the basis of predetermined responses thereto; providing a fixed time period after the primary interview survey, performing a secondary interview survey separately with a management zone and a site representative, and obtaining predetermined response information; and having the evaluator perform a rating evaluation on the basis of the response results and a reference rating value, and transmit an obtained rating to the subject via the network.

### BACKGROUND OF THE INVENTION

1. Field of the Invention

The present invention relates to an environment rating evaluation method, and more particularly to a method and a system thereof for providing an objective evaluation of the environmental preservation activities of a business enterprise or the like, and implementing environment rating of the business enterprise or the like.

The present invention may be used to provide a novel environment rating evaluation method and a system thereof which enables an objective and transparent environment rating evaluation to be implemented.

2. Description of the Related Art

In recent years, with efforts toward environmental preservation being taken ever more seriously, business enterprises and the like have been strongly urged to reduce the impact of economic activity on the natural environment as far as possible. Business enterprises themselves have also come to realize the importance of predicting the impact of their various activities on the environment and implementing the required environmental measures, or in other words making efforts toward environmental preservation. Moreover, with the globalization of environmental problems from regional pollution issues to problems on a global scale, such as global warming prevention measures, it is becoming more and more important for business activities to be conducted with due consideration to the environment, in response to the strong opinions of the stakeholders in business enterprises such as consumers, investors, and trade clients. In light of these circumstances, business enterprises and the like have begun to display a trend of participating in environmental preservation activities of their own accord, rather than under legal restrictions, leading to an increase in the number of business enterprises and so on which employ systems such as ISO14001 and the Environmental Preservation Activities Program (EA21) instituted by the Japanese Ministry of the Environment, for example.

Various efforts have been made to promote the environmental preservation activities of business enterprises and the like by having business enterprises, associations, and soon adopt various types of commendation systems, but in reality there are many examples in which these efforts stop at the implementation of pollution control provisions or various types of superficial environmental preservation activities, which have little hope of ever being implemented effectively and often lack objectivity and transparency. Hence, despite the importance of predicting the impact of phenomena occurring as a result of business activity and the like on the environment, and evaluating these predictions objectively, little progress has been made up to the present in finding effective solutions, even with efforts made by the business community such as those described above.

Incidentally, a great deal of environment-related technology has been proposed in the prior art with the object of realizing environmentally conscious business activities. Here, several representative examples thereof are cited. Examples of this proposed prior art include an environment consideration type material ordering system in which materials can be selected and ordered in consideration of environmental aspects when the materials are procured (see Japanese Laid-Open Patent Application Publication No. H10-312417, for example), a method and device for evaluating environment influence in which the influence of actions executed by a business enterprise or the like on the environment is evaluated and an environment influence evaluation table is created (see Japanese Laid-Open Patent Application Publication No. 2000-20588, for example), and a method for making a checklist of selective support for environmental measures, with which the influence of business activities on the environment can be analyzed more accurately, and which is useful when selecting and adopting important environmental measures with as little omission as possible (see Japanese Laid-Open Patent Application Publication No. 2002-51599, for example).

Further proposals include a marketing method and system for matching the environment-related problems and so on of a business enterprise with solutions and presenting the most appropriate solutions to the problems to business enterprises and the like which have no experts (see Japanese Laid-Open Patent Application Publication No. 2002-183396, for example), an electronic bidding system for use in green purchasing, in which environmentally friendly products are prioritized (see Japanese Laid-Open Patent Application PublicationNo. 2002-230355, for example), and a diagnosing and evaluating method, and an information providing system therefor, for providing a user with various information relating to the barrier-free degree of a product over a network by gathering over the network the usage condition of a product, environment, service, or the like of an arbitrary user, as well as an evaluation relating to the barrier-free capability of the product, its necessity, and soon, and diagnosing and evaluating the barrier-free degree of the product (see Japanese Laid-Open Patent Application Publication No. 2002-259814, for example).

Hence, various methods have been proposed in the prior art for implementing or evaluating environmentally friendly activities in a business enterprise or the like. At present, however, no effective method has been established for providing an environment rating evaluation in which the environment rating of a business enterprise or the like can be evaluated objectively and transparently on the basis of such environmental preservation activities, and therefore strong demands have been made in this technical field for the development of a novel evaluation method with which the environmental preservation activities of a business enterprise or the like can be evaluated objectively, and an appropriate, fair environmental rating evaluation can be implemented.

### SUMMARY OF THE INVENTION

The present invention has been developed as a result of committed research undertaken to solve the problems described above, and it is an object thereof to provide a novel environment rating evaluation method with which an environment rating evaluation can be performed on a business enterprise or the like in a neutral, fair manner by evaluating the environmental preservation activities of the business enterprise or the like objectively and transparently, and digitizing the evaluation result. Another object of the present invention is to provide an environment rating evaluation method which enables even midsize and small organizations to participate in environmental preservation activities of their own accord and receive an environment rating using these environmental preservation activities directly as an index. A further object of the present invention is to provide an environment rating system for implementing environment rating on business enterprises and the like over the Internet.

To achieve these objects, the present invention is constituted by the following technical means.

(1) An environment rating evaluation method comprising the steps of:

having a rating subject such as a rating subject business enterprise input predetermined response information into primary survey items of a predetermined environment rating distributed via a network, and return the response information to a rating evaluator;

having the evaluator distribute secondary survey items to the subject, perform a primary interview survey, and conduct an investigation through data processing on the basis of predetermined responses thereto;

providing a fixed time period after the primary interview survey, performing a secondary interview survey separately with a management zone and a site representative, and obtaining predetermined response information; and

having the evaluator perform a rating evaluation on the basis of the response results and a reference rating value, and transmit an obtained rating to the subject via the network.

(2) The evaluation method according to (1), wherein the secondary survey items are constituted by reconfiguring a part or all of the primary survey items in an interview survey format.

(3) The evaluation method according to (1), wherein the evaluator obtains direct response information from the subject by double-checking the primary survey items and confirming with the subject the responses to the secondary survey items during the primary interview survey.

(4) The evaluation method according to (1), wherein the evaluator performs the rating evaluation on the basis of numerical value results, which are obtained by subjecting the response results to digitization through data processing using a predetermined point evaluation method, and the reference rating value.

(5) An environment rating evaluation system comprising:

means for distributing primary survey items of a predetermined environment rating to a rating subject via a network;

means for having the subject input predetermined response information and return the response information to a rating evaluator;

means for having the evaluator distribute secondary survey items to the subject, and receive predetermined response information;

means for subjecting the response results to digitization through data processing using a predetermined point evaluation method; and

means for calculating a rating evaluation value on the basis of the numerical value results and a reference rating value.

(6) The evaluation system according to (5), comprising means for subjecting the response results to digitization through data processing using a rating data processing unit in a database server of the evaluator.

The present invention will now be described in further detail.

The flowchart in FIG. 2 shows an example of environment rating processing according to the present invention. In this method, first an evaluator (to be referred to as “rating side” hereafter) who performs the environment rating evaluation extracts a rating subject such as a business enterprise to be rated (to be referred to as “subject enterprise” hereafter). In this case, the subject enterprise is extracted in consideration of various basic information obtained during a preliminary survey, for example the contribution of the top management people (the management zone) to the environment, the extent to which the environment is acknowledged, the extent to which the enterprise affects the environment, and so on. However, in the present invention the items included in this basic information may be set appropriately, and there are no particular limitations thereon. Next, the rating side checks the willingness of the extracted business enterprise to implement the environment rating, and sets a business enterprise that has consented to and requested rating as a rating implementation enterprise. Next, the rating side transmits survey items, a manual, and required information to the rating implementation enterprise over a network. Having received this information, the business enterprise examines the content of the information and determines whether or not to participate in the environment rating as a subject enterprise. If the business enterprise wishes to undergo an environment rating investigation, it inputs predetermined data into the survey items in accordance with the manual, and if not, the business enterprise selects CANCEL. The business enterprise then returns the various transmitted information to the rating side over the Internet.

The rating side analyzes and evaluates the content of the returned survey items, and distributes primary interview survey items, a manual, and required information over the Internet to the business enterprise which requires a survey. The rating side then analyzes and evaluates the returned responses. Following the primary interview over the Internet, the subject enterprise is provided with a fixed time period to implement improvements, maintenance, and soon. The interview survey performed over the Internet is not limited to the above example, and may be replaced by an on-site interview survey. Following the fixed time period, a secondary interview survey is performed. The secondary interview survey is performed as an on-site interview survey conducted separately with the management zone and a site representative. For example, a specialist investigator who has received education and training from a rating committee disposed on the rating side visits the business enterprise to double-check the results of the previous questionnaire survey, and confirms the data of the primary interview survey distributed over the Internet, the state of the improvements implemented during the fixed time period, and so on. The investigator conducts the secondary interview with the management zone and a site representative separately, inspects the site together with these people, and records confirmed predetermined data in a database. This data recording operation may be performed by inputting the predetermined data into the database over the Internet from a terminal device on the business enterprise side, or by inputting the predetermined data directly from a terminal device on the rating side.

Next, the interview survey data and on-site survey results recorded in the database are digitized by means of data processing on the basis of a predetermined point evaluation method, and tallied as numerical value data. The rating side determines the environment rating of the business enterprise in accordance with the obtained tallied data, and informs the enterprise side of the result. The rating side transmits the rating result to the enterprise side over the Internet, but the present invention is not limited thereto, and the rating result may be delivered by appropriate distributing means. An environment rating certificate is issued together with the rating result, and these may be made widely available to the general public via the Internet.

The flowchart in FIG. 3 shows another example of the environment rating processing of the present invention. In this method, first the rating side extracts a rating subject enterprise, checks the willingness of the enterprise to implement the environment rating, and distributes environment rating survey documents to the implementation enterprise that confirms its willingness using E-mail or a downloading system. The subject enterprise enters predetermined data in the survey items of the survey documents, and returns the documents to the rating side using E-mail. The rating side performs data processing on the returned responses, then conducts questions and answers (an interview) via E-mail and performs data processing and classification on the basis of the responses returned by the subject enterprise, and thus performs a primary evaluation.

Next, the rating side transmits an interview notification to the subject enterprise by E-mail, conducts an interview with a site representative regarding the data entered in the survey items of the environment rating survey documents, tallies the results of the data entered in the survey items of the environment rating survey documents, and digitizes the tallied results by means of data processing on the basis of a predetermined point evaluation method. A secondary evaluation is then conducted by an evaluation committee. Next, an investigator on the rating side conducts a face-to-face interview with the top management regarding the data entered in the survey items of the environment rating survey documents, tallies the results thereof, and creates an investigation report. An investigation committee informs the business enterprise of the rating result and publishes the rating result on the Internet.

One of the features of the method of the present invention is that the evaluation is performed numerically by digitizing each survey item on the survey document on the basis of a predetermined point evaluation method, and converting the survey items that are actually filled in by the business enterprise into numerical values. Other prominent features of the present invention include the facts that the series of processes performed between the rating side and subject enterprise is implemented electronically via Internet means, accurate survey results can be obtained by conducting a primary interview (questions and answers) over the Internet and conducting a secondary interview face-to-face in relation to the data entered in the survey items, and objective survey results for the entire subject enterprise can be learned by conducting the secondary interview separately with the site representative and the management zone. By combining these constitutional elements of the method of the present invention organically, it is possible for the first time to obtain accurate environment rating survey results from the subject enterprise and achieve an objective understanding of the environment rating survey results of the entire subject enterprise, both of which are difficult when conventional methods are used.

The environment rating created using the method of the present invention provides advantages including the following: creation and investigation of the various data generated during implementation of the rating processing are performed by means of IT processing; a digitized rating result is obtained; a fixed time period is inserted between the primary Internet interview survey and the secondary interview survey in order to assess the degree of efforts at improvements and the like of the environmental preservation activities by the business enterprise quantitatively during this time period; interviews are conducted with the management zone and the site representative separately so that differences in the levels of awareness, enthusiasm, and so on between the former and latter can be learned; an objective rating result is obtained using data that are created through mutual information exchange between the rating side and enterprise side, including the on-site survey of the rated enterprise; and by making the rating result widely available over the Internet, a general user (consumer) is able to gain an objective understanding of the degree to which the business enterprise is making efforts in relation to the environment. A rating having a particularly high degree of precision can be obtained by confirming (digitizing) the degree of efforts at improvements (digitizing) of the environmental preservation activities by the business enterprise quantitatively between the primary interview and secondary interview, and differences in the levels of awareness, enthusiasm, and so on between the management zone and the site representative.

### BRIEF DESCRIPTION OF THE DRAWINGS

FIG. 1 shows an example of a network system used in the method of the present invention;

FIG. 2 is a flowchart showing an example of environment rating processing according to the present invention;

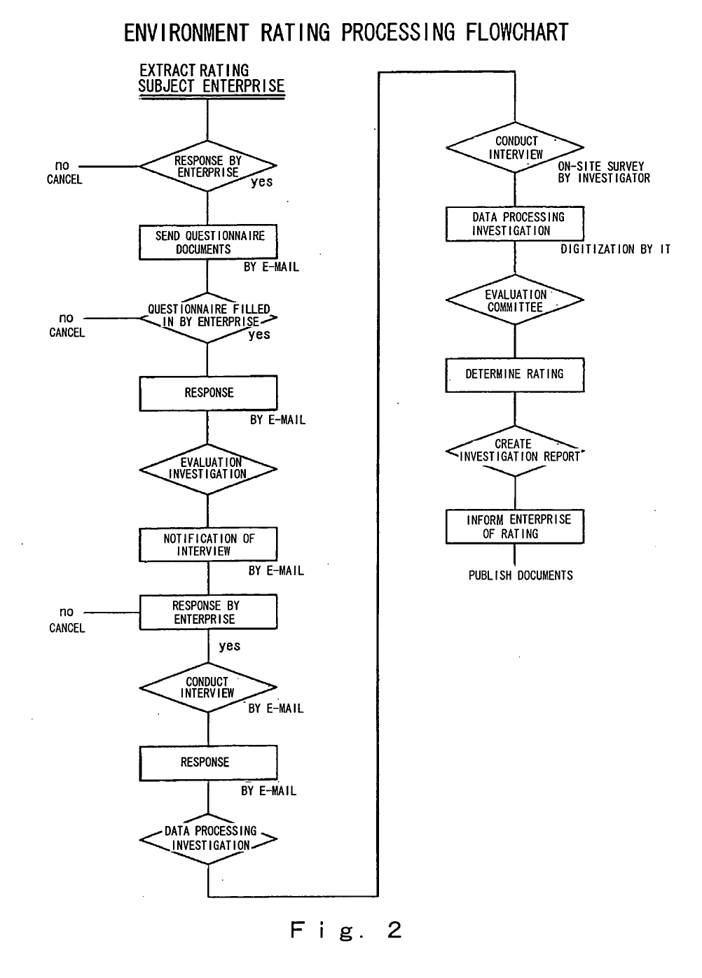

FIG. 3 is a flowchart showing another example of the environment rating processing of the present invention;

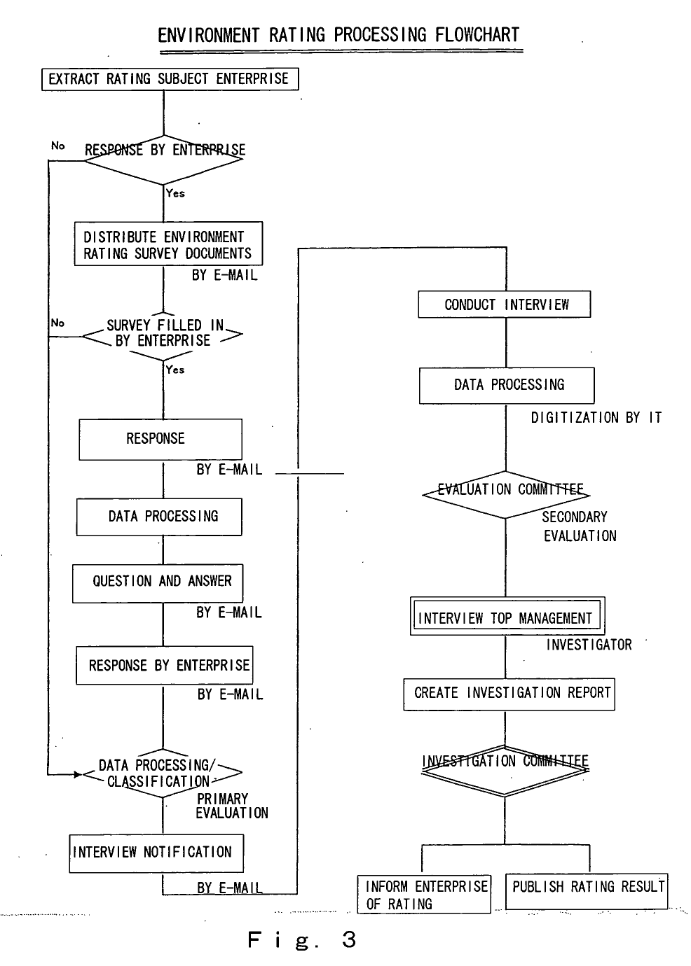

FIG. 4 shows an example of a rating survey sheet (in a checklist format) used in the present invention;

FIG. 5 shows an example of a rating survey sheet (in a checklist format) used in the present invention;

FIG. 6 shows an example of a data input sheet (in a data input format) used in the present invention;

FIG. 7 shows an example of an interview survey checklist used in the present invention; and

FIG. 8 is a block diagram showing an example of the network system used in the present invention.

### DETAILED DESCRIPTION OF THE EMBODIMENTS

Next, an embodiment of an environment rating evaluation method according to the present invention will be described in detail.

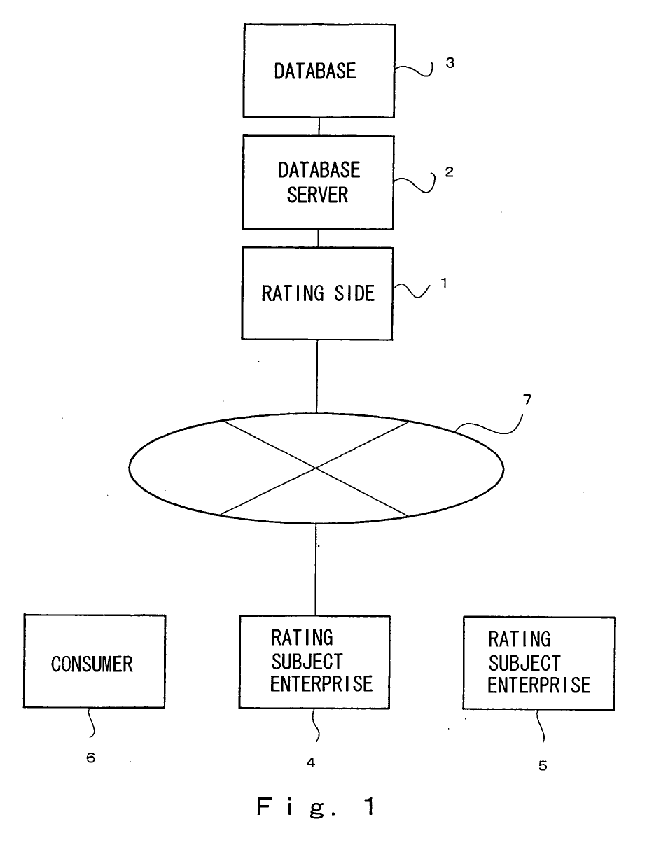

FIG. 1 shows a network system used in the environment rating evaluation method of the present invention. The network system comprises a database 3 disposed on a rating side 1, in which various information is stored and recorded, and a database server 2 which performs information data output, information data input, and data processing in relation to the database 3. The database 3 and database server 2 and a terminal device of a rating subject business enterprise are connected to each other via a network 7. A preferred example of this network is the Internet, which provides a network connection to consumers (users), third party institutions, and so on. The database 3 stores data such as the following: information relating to the rating subject enterprise; information, a manual, and other information relating to a questionnaire survey transmitted to the subject enterprise; data input into items on the questionnaire survey and returned from the business enterprise side; information relating to an interview survey; interview survey data; comparison data for comparing survey results to a predetermined rating evaluation reference, subjecting the survey results to data processing, and tallying the survey results as numerical value data; and so on.

For example, the rating side 1 creates question information required to perform the rating evaluation, a questionnaire survey format, and a manual, and stores, records, and files these items in the database 3. The information is stored and recorded by a question creator, for example, who calls up the database server 2 from a terminal device on the rating side so that the database 3 is output and displayed on a screen, and then opens an information input page and inputs the question information required to perform the rating evaluation, the questionnaire survey format, the manual information, and other predetermined information. The information is transmitted from the database sever 2 on the rating side to the rating subject enterprise over the network 7, but instead, for example, the rating subject enterprise may connect to the database server 2 storing the information relating to the rating evaluation, such as the question information, questionnaire survey format, and manual information, from a terminal device via the network 7 using an identification code unique to the database, for example a domain name, an ID code, or the like. The rating subject enterprise then opens a homepage (data file) containing the recorded question information relating to the environment rating from the database 3 of the database server 2, and obtains the predetermined information.

The enterprise side opens the question information transmitted from the rating side, or opens file pages upon reception of the homepage containing the question information and so on. As a result, the file pages are output and displayed on an output screen of the terminal device, and thus predetermined survey items required in the rating investigation, the question information, the manual, and other information are output and displayed as choices, input items, and so on, for example. Examples of this output information include: business enterprise information, including an outline of the business activities of the enterprise; an outline of the environmental responsiveness of the business enterprise; applied ordinances; the current state of the load placed on the environment; a data input sheet for an environmental activity evaluation program into which the items described above are entered; and an environmental preservation effort checklist including, for example, suppression of exhaust gases such as CO₂ and NOₓ, waste disposal restrictions/recycling and appropriate processing, prevention of atmosphere pollution, water pollution, and so on, reduction of the load placed on the environment by transportation, measures taken in relation to chemical substances, environmental considerations during product development design, and so on, environmental considerations during building construction, demolition, and development operations, green purchasing, maintenance of frameworks and systems for preserving the environment, environmental education and the promotion of environmental preservation activities, information provision/social contribution/regional environmental preservation, eco-business/technological development, consideration of international cooperation and overseas enterprises, and environmental considerations relating to investment and financing. However, the present invention is not limited to these examples, and any equivalent or similar information may be used in a similar manner.

Next, the business enterprise inputs predetermined data in response to the survey items, questions, and so on displayed on the screen, and then transmits this response information to the database sever 2 over the network 7. Preferable examples of the format of the survey items, questions, and so on output and displayed on the screen of the terminal device on the business enterprise side include a text input format, a check format, a circle or cross response format, a multiple choice format, a closed end format, and a combination of these formats, for example, but the present invention is not limited to these examples. The response information of the business enterprise transmitted to the database server 2 from the terminal device on the business enterprise side is recorded in the database 3 via the database server 2, and compiled by means of data processing.

Alternatively, for example, an input page for recording legal information relating to the business enterprise may be set in the file pages of the survey items, question information, and so on transmitted from the database 3, and after the business enterprise has recorded business enterprise information in advance, legal information unique to the business enterprise, for example an affiliate code, password, verification code, domain name, ID code, or similar may be output to and displayed on the terminal device on the business enterprise from the database server 2, enabling the business enterprise to obtain this legal information. Then, at the same time as, or before or after, the business enterprise responds to the questionnaire survey, the identification information is input and recorded, whereupon the response information from the business enterprise side is transmitted to the database sever 2, subjected to data processing, and recorded in the database 3.

The response information recorded and compiled in the database 3 is subjected to an evaluation investigation on the rating side. For example, evaluations such as analyzing the extent of efforts made by the business enterprise in relation to the environment and determining whether to continue or halt the investigation are made. If, as a result of the evaluation, it is determined that the business enterprise does not require another investigation, the reasons therefor are transmitted to the business enterprise side over the network, for example. As for the other business enterprises, an evaluation result informing the business enterprise that an interview survey is to be implemented is transmitted over the network. Next, the rating side creates survey items for the interview survey, question information, manual information, and other information relating to the business enterprise which has requested an interview survey, records and files this information in the database, and transmits this filed information to the terminal device on the business enterprise side prior to a primary interview survey using the same system as that employed during the previous questionnaire survey. Thus the filed information is output to and displayed on the output screen of the terminal device.

Next, the primary interview survey is implemented and returned to the rating side via the network, for example. A fixed time period is provided after the primary interview survey. During the fixed time period, the business enterprise side can implement in-house maintenance and improvements. After the fixed time period, a secondary interview survey is implemented. In the secondary interview survey, a specialist technician who has received education and training from a rating committee disposed on the rating side, for example, visits the business enterprise in person to double-check the results of the questionnaire survey and conduct separate secondary interviews with the management zone and site representative on the business enterprise side regarding the data distributed over the Internet in advance. The results of these secondary interviews are transmitted over the network 7 to the database server 2 as interview survey results, or input directly into the database server 2, recorded in the database 3, and compiled by means of data processing. The compiled data are compared to an environment rating evaluation reference, and then compiled by means of data processing. An evaluation committee disposed on the rating side performs a final rating determination on the basis of the digitized data, and informs the business enterprise side of the result of the determination in the form of an investigation report that is transmitted together with attached reasons.

The compiled response information, and the investigation and evaluation results investigated and evaluated on the basis of this response information, may be viewed by the business enterprise itself, other business enterprises, and consumers which are connected to the database server 2 over the Internet by opening an information viewing page showing the evaluation results. Hence, with the method of the present invention, information processing based on mutual information exchange between the rating side and business enterprise side and information processing produced by the implemented survey can be combined organically by having the rating subject enterprise connect to the database server 2 via the network 7 to participate in the environment rating system. As a result, objective and transparent data processing can be realized, and therefore environment rating, which is difficult to perform objectively using conventional methods, can be performed on the basis of objective numerical values.

In the present invention, examples of the network include the Internet, a Local Area Network, a Wide Area Network, and a private line. In this case, the communication method may be either wired or wireless. The database server is preferably constituted by a recording device such as ROM, RAM, or a hard disk for storing predetermined data and programs, a CPU (central processing unit), an information processing device that is capable of executing information input and output, a personal computer, a portable information processing terminal (PDA), an information processing terminal device such as a mobile telephone, or similar, for example. However, the present invention is not limited to these examples. The database server is connected to a plurality of users via the network, and comprises means for transmitting and receiving various information over the network. The database server may be constituted by a plurality of database servers.

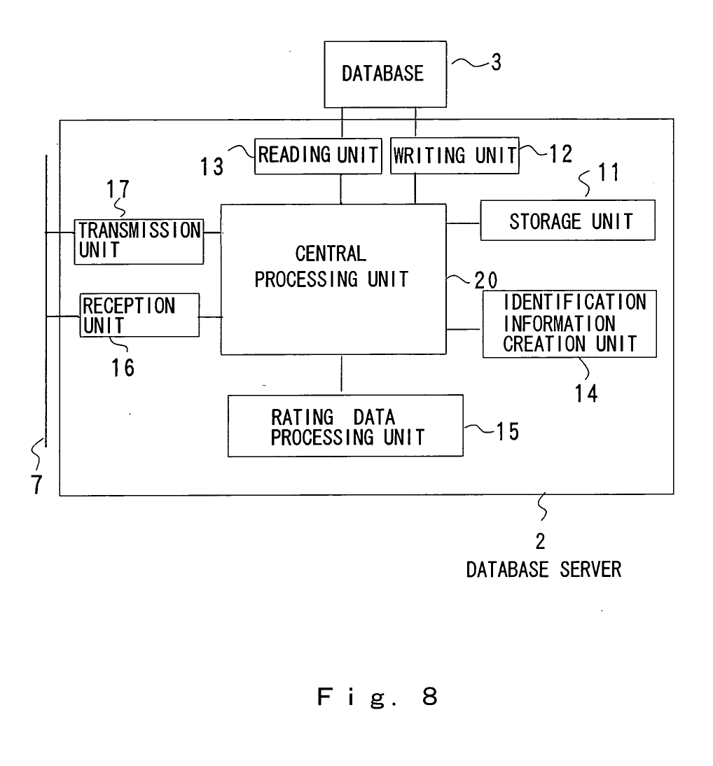

FIG. 8 is a block diagram showing an example of the structure of the database server. The database server comprises a recording device 11 for recording data and programs, a CPU 20, information writing means 12 for writing predetermined information, information reading means 13 for reading predetermined information, receiving means 16 for receiving information from various terminals via the network 7, transmitting means 17 for transmitting information to each terminal device from the database server 2 via the network 7, identification information creating means 14, and rating data processing means 15. However, the present invention is not limited to this example, and any device which exhibits similar functions may be employed. In the present invention, the database server comprises the identification information creating means 14 for creating identification information such as a unique user ID, password, or identification number for connecting to and registering with the server on the basis of legal information that is transmitted from a terminal device of a new user and recorded therein. The legal information of the user and the created identification information unique to the user are written into the database by the writing means and recorded.

The database server also comprises the rating data processing means 15 for data-processing the response information transmitted from the terminal device of the user on the basis of a predetermined calculation processing program, and outputting the obtained evaluation result. The evaluation result is written into the database by the writing means and recorded.

Next, the format of the questionnaire survey will be described in detail.

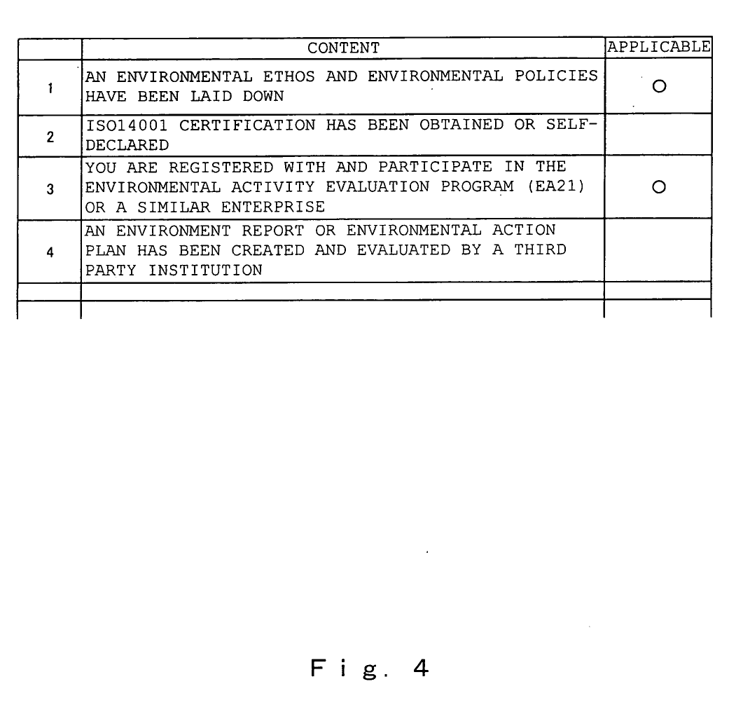

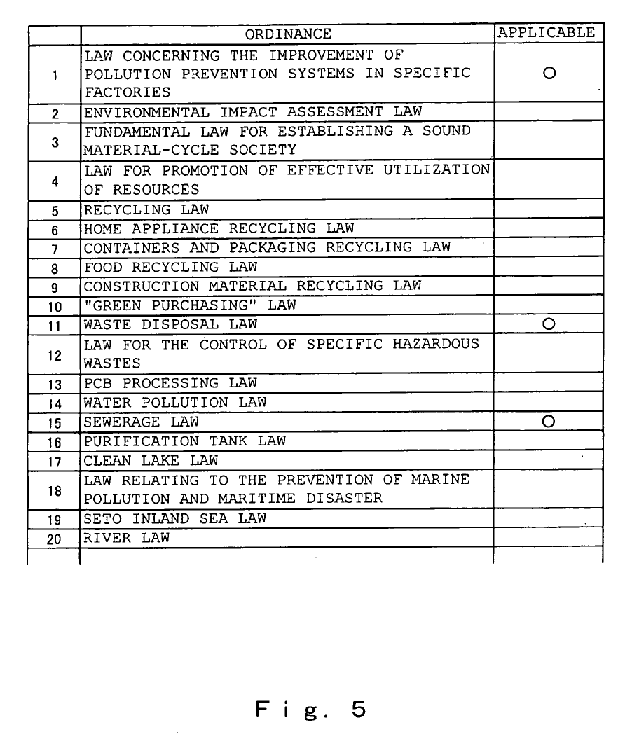

As described above, examples of the survey items include 1. Company name, 2. Outline of Business Activities, 3. Outline of Environmental Responsiveness, 4. Applied Ordinances, 5. Current State of Load placed on Environment, and 6. Environmental Accounting. Of these items, the third item uses a system of checking corresponding items relating to the content of environmental preservation activities currently in practice, the fourth item uses a system of checking corresponding boxes in relation to environment-related statutes currently being applied by the business enterprise, and the fifth item uses a system of inputting data for the past three years, for example, into a predetermined data input sheet, and a method of entering the state of current efforts on an environmental preservation effort checklist. FIG. 4 shows an example of the survey format relating to the outline of environmental responsiveness in item 3, although the content of the survey is not limited to the example shown in FIG. 4. FIG. 5 shows an example of the survey format relating to the applied ordinances in item 4, although the content thereof may be modified appropriately according to the aims of the survey and the subject enterprise.

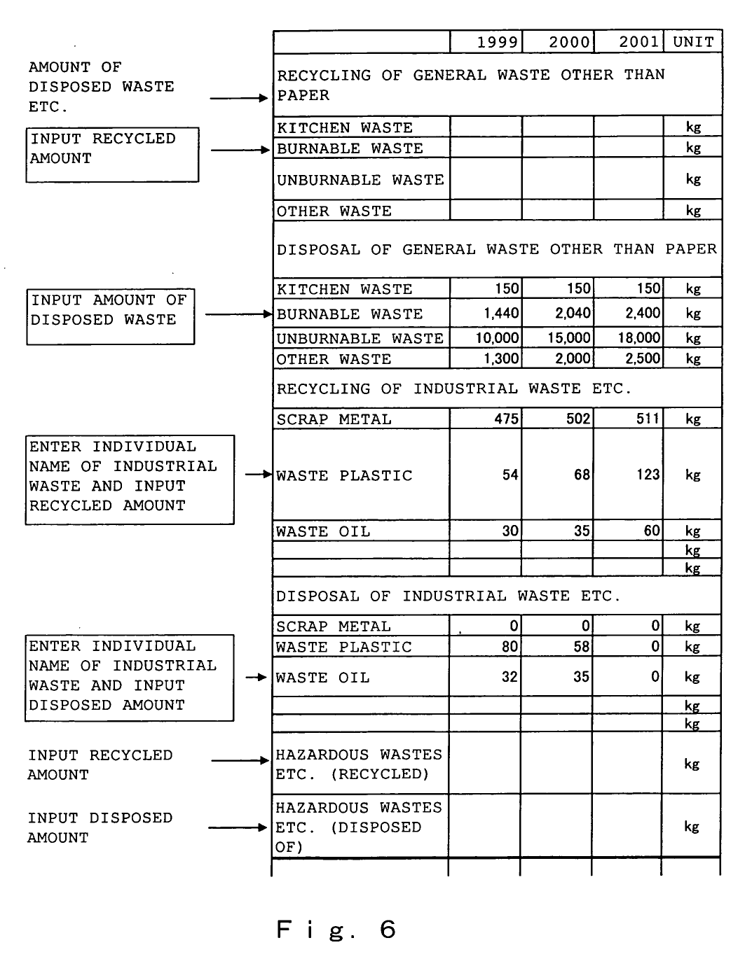

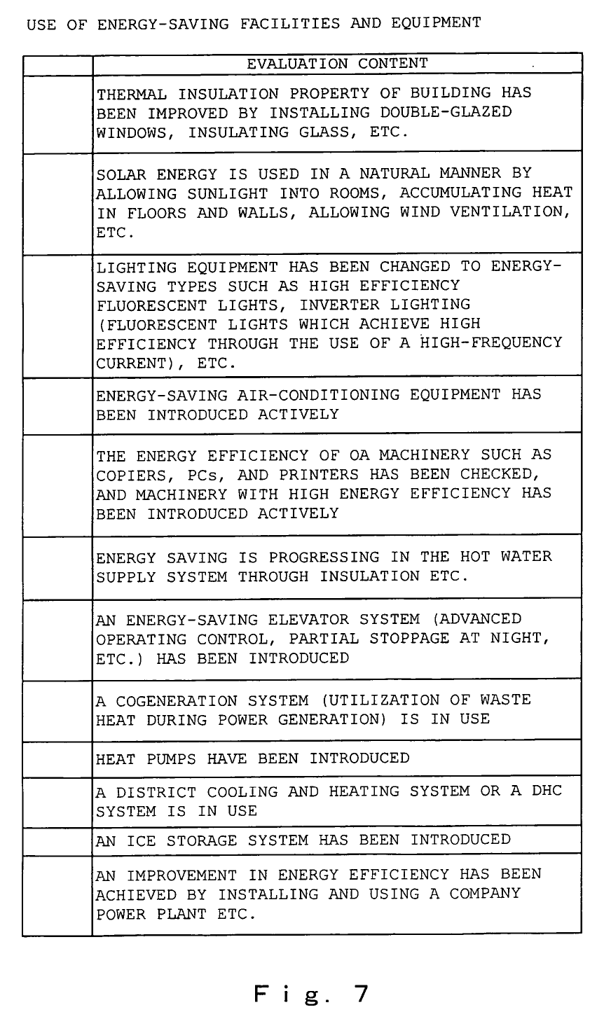

FIG. 6 shows a part of the data input sheet relating to the current state of the load placed on the environment in item 5. The present invention is not limited to these survey items, and the survey items maybe modified according to the aims of the survey and the subject enterprise. FIG. 7 shows a part of the checklist relating to environmental preservation efforts within the current state of the load placed on the environment in item 5. This evaluation content may also be selected and employed as desired according to the aims of the survey and the subject enterprise.

FIG. 4 is an example of check items that are output and displayed as a page screen on the screen of the business enterprise side terminal device. An empty box or a corresponding box for entering a circle is provided for each check item. The business enterprise side inputs a predetermined check mark in the corresponding box in response to the questions shown in FIG. 4 that are output and displayed on the screen of the terminal device, and transmits the results to the database server 2 on the rating side via the network 7. The results are recorded in the database 3 and compiled by means of data processing. The survey items relating to the applied ordinances shown in FIG. 5 are subjected to similar processing to that shown in FIG. 4.

The data input sheet shown in FIG. 6 is an example of a data input sheet that is output and displayed as a page screen on the screen of the business enterprise side terminal device, similarly to the case shown in FIG. 4. Empty boxes for inputting predetermined data are provided for each survey item. The business enterprise side inputs predetermined numerical values into the input boxes corresponding to the survey items shown in FIG. 6, which are output and displayed on the screen of the terminal device, in accordance with the input procedures written in the left-hand side boxes, and transmits the results to the database server 2. If necessary, survey items may be added to the data input sheet so that predetermined data can be inputted. FIG. 6 shows an example in which survey items relating to waste disposal amounts are set, but any survey items that can be answered through the input of numerical values and which indicate the current state of the load placed on the environment may be set in the data input sheet. For example, survey items which indicate the amount of carbon dioxide emissions include fuel, utility power, automobile fuel, annual usage of other energy, ratio of fuel used in facilities where NOₓ reduction measures are implemented, amount of recycled general waste other than paper, amount of recycled industrial waste, amount of disposed industrial waste, natural resource usage, annual paper usage and introduction ratio of recycled paper (non-manual), raw material usage, annual output of water pollutants and average concentration thereof, annual chemical handling amount, output amount, and movement amount, and so on.

The environmental preservation effort checklist shown in FIG. 7 contains information that is transmitted to the business enterprise side by the rating side prior to the interview survey. Similarly to the questionnaire survey, the checklist shows examples of check items that are output and displayed as a page screen on the screen of the terminal device on the business enterprise side. The business enterprise side inputs the state of implementation corresponding to the evaluation content by inserting 2 for widely implemented, 1 for partially implemented, 0 for not implemented, and n for not applicable, and then transmits the checklist to the database server 2, or provides the investigator with the input data during the interview survey so that the investigator can input the data directly into the database server 2. The survey items contained in the checklist shown in FIG. 7 are examples.

Other examples of items that may be set include use of environmentally-friendly raw materials/fuels, consideration of daily business management, consideration of production processes, natural energy/unused energy usage, waste disposal reduction, recycling, and appropriate processing, efforts to reduce waste itself, promotion of recycling in the office and soon, consideration of packaging and so on during shipment, sale, etc., efforts made during production process, appropriate processing of industrial waste, and so on. Other items include an item relating to the prevention of atmospheric pollution, water pollution, and so on, an item relating to reduction of the load placed on the environment by transportation, an item relating to measures taken in relation to chemical substances, an item relating to environmental considerations during product development, design, and so on, an item relating to environmental considerations during building construction, demolition, and development operations, an item relating to green purchasing, an item relating to the maintenance of frameworks and systems for preserving the environment, an item relating to environmental education and the promotion of environmental preservation activities, an item relating to information provision, social contribution, and regional environmental preservation, an item relating to eco-business and technological development, an item relating to consideration of international cooperation and overseas enterprises, an item relating to environmental considerations with respect to investment and financing, and so on.

The check boxes for each survey item and the response information provided by the business enterprise side in response to the questions in each of the survey steps described above are transmitted in sequence to the database server 2 via the network 7, subjected to data processing, and recorded in the database 3.

Next, by means of calculation processing performed by rating evaluation calculation program software in the database server 2, the data are tallied, analyzed, digitized as rating evaluation results, and recorded in the database 3. There are no particular limitations on the rating evaluation calculation program as long as it comprises a processing function for tallying, analyzing, and evaluating as a numerical rating value the response information transmitted from the business enterprise side. The rating evaluation produced in this processing is passed to the evaluation committee disposed on the rating side. The evaluation committee determines a rating, creates an investigation report, and transmits these to the business enterprise side. Moreover, as a rule the rating evaluation is made available to the general public via the network 7 so that consumers can view this information over the Internet. Typically, the evaluation results are provided basically in a quantitative form having a numerical value which indicates a ranking, but if necessary, the evaluation results may be provided using a qualitative evaluation reference.

In the present invention, the results of the rating evaluation are output to the business enterprise side via the network 7 and displayed on the screen of the terminal device. Instead of this rating evaluation result display method, the rating evaluation results may be displayed appropriately using a method such as graph display or text display, for example. Furthermore, the rating ranking may be tallied, output, and displayed using an appropriate tallying method such as classification by industry, region, individual, capital, scale, and number of years since establishment.

The present invention relates to a method of performing an environment rating evaluation using a network system. According to the present invention, the following effects are obtained.

(1) The environmental preservation activities of a business enterprise can be digitized objectively.

(2) An evaluation of the impact of business activities on the environment can be implemented simply and precisely.

(3) Processing for creating and investigating various data can be performed entirely by means of IT, and therefore the method of the present invention can be applied widely even to business enterprises that do not have specialist environmental staff.

(4) To complete the predetermined procedure, the rating subject enterprise merely has to input data and marks in accordance with predetermined survey items that are output to and displayed on a screen of a terminal device, and transmit the response information to a database server.

(5) A precise rating can be realized by integrating the self-assessed response information gathered via the network with response information obtained through an on-site interview survey.

(6) The time and cost required for the rating evaluation investigation process can be reduced greatly.

(7) Consumers can learn the current state of the environmental preservation activities of the business enterprise easily and accurately by viewing the published environment rating information on the Internet.

(8) By providing a fixed time period following a primary interview survey, and then performing a secondary interview survey, the degree of efforts at improvements of the environmental preservation activities by the business enterprise during the fixed time period can be quantified quantitatively.

What is claimed is:

1. An environment rating evaluation method comprising the steps of:
having a rating subject such as a rating subject business enterprise input predetermined response information into primary survey items of a predetermined environment rating distributed via a network, and return said response information to a rating evaluator;
having said evaluator distribute secondary survey items to said subject, perform a primary interview survey, and conduct an investigation through data processing on the basis of predetermined responses thereto;
providing a fixed time period after said primary interview survey, performing a secondary interview survey separately with a management zone and a site representative, and obtaining predetermined response information; and
having said evaluator perform a rating evaluation on the basis of said response results and a reference rating value, and transmit an obtained rating to said subject via said network.

2. The evaluation method according to claim 1, wherein said secondary survey items are constituted by reconfiguring a part or all of said primary survey items in an interview survey format.

3. The evaluation method according to claim 1, wherein said evaluator obtains direct response information from said subject by double-checking said primary survey items and confirming with said subject said responses to said secondary survey items during said primary interview survey.

4. The evaluation method according to claim 1, wherein said evaluator performs said rating evaluation on the basis of numerical value results, which are obtained by subjecting said response results to digitization through data processing using a predetermined point evaluation method, and said reference rating value.

5. An environment rating evaluation system comprising:
means for distributing primary survey items of a predetermined environment rating to a-rating subject via a network;
means for having said subject input predetermined response information and return said response information to a rating evaluator;
means for having said evaluator distribute secondary survey items to said subject, and receive predetermined response information;
means for subjecting said response results to digitization through data processing using a predetermined point evaluation method; and
means for calculating a rating evaluation value on the basis of said numerical value results and a reference rating value.

6. The evaluation system according to claim 5, further comprising means for subjecting said response results to digitization through data processing using a rating data processing unit in a database server of said evaluator.
